(19) United States
(12) Patent Application Publication
(10) Pub. No.: US 2026/0192646 A1
(43) Pub. Date: Jul. 9, 2026

(54) ROTATING SHAFT STRUCTURE AND A PICKUP TRUCK REAR COVER EQUIPPED THEREWITH

(71) Applicant: Wenzhou L-Ray Auto Parts Co.,Ltd., Wenzhou (CN)

(72) Inventors: Dingqi Ma, Wenzhou (CN); Shangyi Xie, Wenzhou (CN)

(21) Appl. No.: 19/026,133

(22) Filed: Jan. 16, 2025

(30) Foreign Application Priority Data
Jan. 7, 2025 (CN) 202510020071.6

(51) Int. Cl. B60J 7/16; B60J 10/90

(52) U.S. Cl. CPC B60J 7/1607; B60J 10/90

(57) ABSTRACT

The present invention discloses a rotating shaft structure and a pickup truck rear cover equipped therewith, comprising a basic part and a rotating part. Wherein at least one rotation space is provided along the horizontal direction in the basic part, a limiting body is arranged at the opening of the rotating space. The limiting body includes an arc body and a transition body, a contact surface is formed between the arc body and the transition body. The rotating part is provided with a rotating body, with a contact body on the side of the rotating body facing the contact surface, thereby expanding the range of the rotating space and enhancing the stability during use.

### CROSS-REFERENCE TO RELATED APPLICATIONS

This application claims priority to Chinese Application 2025100200716, filed on Jan. 7, 2025, which is incorporated herein by reference in its entirety.

### FIELD

The present invention is relevant to the technical field of automotive parts, especially a rotating shaft structure and a pickup truck rear cover equipped therewith.

### BACKGROUND

Pickup trucks, as a common type of vehicle, offer car-like comfort without losing power. Due to its strong cargo carrying and adaptability to poor road conditions and its strong overall performance, pickup trucks have become one of the most common off-road vehicles nowadays. To enable pickup trucks to adapt to a wider range of environments, most existing pickups require a car cover. which is made of a plurality of panels spliced together and and utilizes a rotating shaft structure for folding and flipping. When in use, the car cover will be folded, when not in use it will lay flat to cover the rear cargo hopper.

In existing rotating shaft structures, the rotational bump of the rotating shaft is circular. This setting causes the rotational rod, which engages with the bump during panel rotation, to push the bump outward due to insufficient rotational space, resulting in the cover panel detaching or separating.

The embodiments of the present invention provide a rotating shaft structure and a pickup truck rear cover equipped therewith to at least address the technical problem of the cover detaching and separating due to insufficient rotation space.

In order to solve the above problems of the existing technology, the technical solution adopted in the invention is as follows:

On one hand, the present invention discloses a rotating shaft structure, comprising a basic part and a rotating part.

A basic part is provided with at least one rotation space along the horizontal direction, a path is formed inside the rotation space. A limiting body is arranged at the opening of the rotation space. The limiting body includes an arc body and a transition body, a contact surface is formed between the arc body and the transition body.

A rotating part is provided with a rotating body, with a contact body on the side of the rotating body facing the contact surface.

Wherein, the rotating body moves along the path inside the rotation space, enabling relative angular displacement between the rotating part and the basic part. When the rotating part and the basic part are in a horizontal state, the contact body clamps the contact surface to restrict the connection state between the basic part and the rotating part. Additionally, the portion of the transition body located within the rotation space is reduced to enlarge the rotation space.

The rotating shaft structure provided in the embodiments of this invention reduces the portion of the transition body located within the rotation space, enlarging the range of the rotation space. Thereby, the rotating body gains a greater rotational margin, preventing the cover panel from detaching or separating due to insufficient rotation space and enhancing the stability during use.

Further the transition body is in the shape of a triangle or a trapezoid or a V-shape. This setting is to reduce the space occupied by the transition body and enlarge the range of the rotation space.

Further, the rotating part comprises a body, a rotating groove is formed between the body and the rotating part, the arc body is rotationally connected to the rotating groove. This setting is to enable coordinated rotation and prevent interference during the rotation process.

Further, a sealing strip is provided at the connection between the basic part and the rotating part. The setting of the sealing strip significantly enhances the seal between the basic part and the rotating part, preventing rainwater and debris from entering the cargo hopper.

Further, a first groove is provided along the outer side of the basic part, while a second groove is provided on the inner side of the rotating part. The first groove and the second groove are provided correspondingly to form a space for accommodating the sealing strip. This setting specifically defines the connection details, wherein the first groove and the second groove are arranged correspondingly to form a space for accommodating the sealing strip.

Further, a first end cap is provided at the end of the basic part, while a second end cap is provided at the end of the rotating part. The second end cap is rotationally connected with the first end cap. This setting seals the ends of the basic part and the rotating part, while also improving the aesthetic appearance.

On the other hand, the present invention discloses a pickup truck rear cover, assembled from multiple panel components spliced together, which are rotatably connected through the rotating shaft structure to allow angular variation between the panel components. This setting enables the angle variation between the multiple panel components.

Further, each panel components comprises a panel body and multiple frames surrounding it. This setting enhances the overall strength and stability.

Further, the pickup truck rear cover is provided with a flat state and a folded state. This setting allows the pickup truck rear cover to switch between the flat state and the folded state according to different usage scenarios.

### BRIEF DESCRIPTION OF THE DRAWINGS

FIG. 1 is a 3D perspective view of the pickup truck rear cover in the embodiment of this invention.

FIG. 2 is an assembly view of the rotating shaft structure and end cap in the embodiment of this invention.

FIG. 3 is a side view of the rotating shaft structure in the embodiment of this invention.

FIG. 4 is a side view of the basic part in the embodiment of this invention.

FIG. 5 is a side view of the rotating part in the embodiment of this invention.

FIG. 6 is a partial schematic diagram I of the transition body as a triangle in the embodiment of this invention.

FIG. 7 is a partial schematic diagram I of the transition body as a trapezoid in the embodiment of this invention.

FIG. 8 is a partial schematic diagram I of the transition body as a V-shape in the embodiment of this invention.

FIG. 9 is a partial schematic diagram II of the transition body as a triangle in the embodiment of this invention.

FIG. 10 is a partial schematic diagram II of the transition body as a trapezoid in the embodiment of this invention.

FIG. 11 is a partial schematic diagram II of the transition body as a V-shape in the embodiment of this invention.

### DETAILED DESCRIPTION OF THE INVENTION

The following instruction further explains the invention's concrete implementation method.

In the description in present invention, it is to be understood that the orientation or positional relationships indicated by the terms “top”, “bottom”, “inside”, “outside”, “top”, “bottom”, “top”, “bottom”, “inside”, “bottom”, “inside”, “outside”, etc. are based on the orientation or positional relationships shown in the accompanying drawings, which serve only to facilitate the description in present invention and simplify the description, and are not to be construed as limiting the present invention in any way as they indicate or imply that the device or element referred to must be constructed and operated with a specific orientation or be constructed and operated in a specific orientation.

In the description of the invention, it should also be noted that, unless otherwise expressly specified and limited, the terms “arranged,” “installed,” “connected,” and “combined” should be understood in a broad sense. for example, it may be a fixing connecting, it can also be a detachable connecting or an integral connecting. it can be a mechanical connecting or an electrical connecting. it can be a direct connecting or an indirect connecting through an intermediate media. And it can be internal connecting within two assemblies. For those of ordinary skill in this field, specific meanings of the above terms in the present invention can be understood in specific situations.

In this invention, unless otherwise stated, directional terms such as “axial,” “circumferential,” and “radial” generally refer to directions defined relative to the rotational axis of the rotor in the drive motor. “Inner” and “outer” refer to the inside and outside of the respective component profiles. The use of terms such as “first,” “second,” etc., is intended to distinguish between different components and does not imply any sequential or hierarchical importance. Furthermore, in the following description, when referring to the drawings, the same reference numerals in different drawings indicate the same or similar elements, unless otherwise explained.

### Embodiments 1

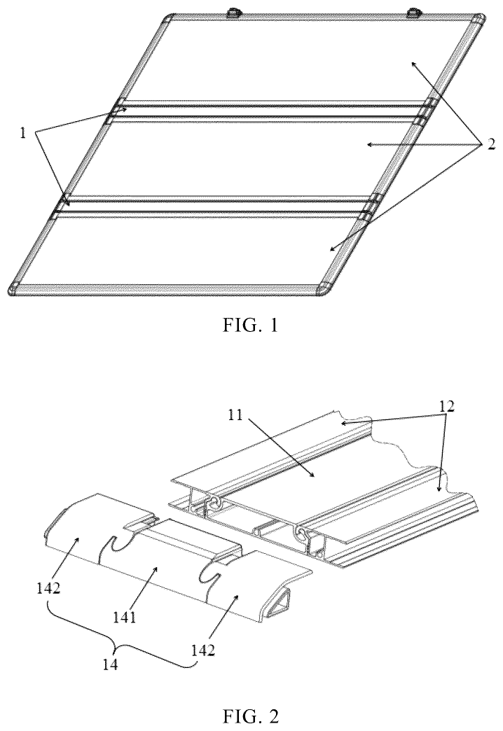

The present invention discloses a rotating shaft structure 1, see FIG. 1 comprising a basic part 11 and a rotating part 12.

See FIG. 4, the following is a specific embodiment of the above mentioned basic part 1, a basic part 11 is provided with at least one rotation space S along the horizontal direction, a path is formed inside the rotation space S. A limiting body 111 is arranged at the opening of the rotation space. The limiting body includes an arc body 1111 and a transition body 1112, a contact surface 1113 is formed between the arc body 1111 and the transition body 1112.

See FIG. 5, the following is a specific embodiment of the above mentioned rotating part 12, a rotating part 12 is provided with a rotating body 122, with a contact body 124 on the side of the rotating body 122 facing the contact surface 1113.

Wherein, the rotating body 122 moves along the path inside the rotation space S, enabling relative angular displacement between the rotating part 12 and the basic part 11. When the rotating part 12 and the basic part 11 are in a horizontal state, the contact body 124 clamps the contact surface 1113 to restrict the connection state between the basic part 11 and the rotating part 12. Additionally, the portion of the transition body 1112 located within the rotation space S is reduced to enlarge the rotation space S.

The rotating shaft structure 1 provided in the embodiments of this invention reduces the portion of the transition body 1112 located within the rotation space S, and enlarge the range of the rotation space S. Thereby, the rotating body 112 gains a greater rotational margin, preventing the cover panel from detaching or separating due to insufficient rotation space and enhancing the stability during use.

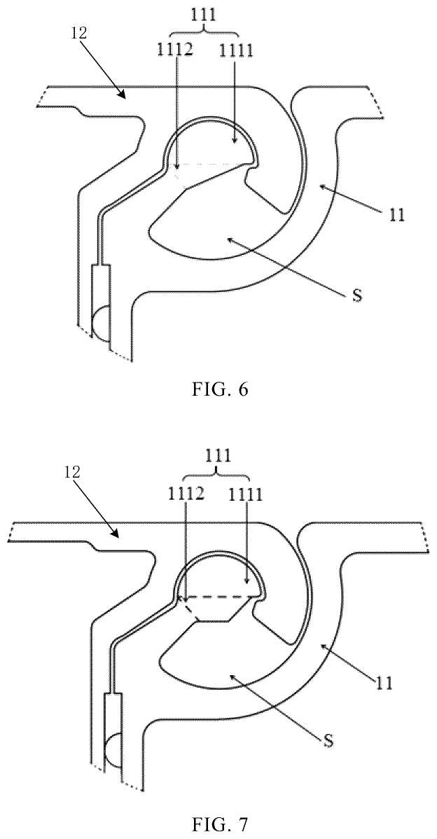

See FIG. 6, the following is a specific embodiment of the above mentioned the transition body 1112, the transition body 1112 is in the shape of a triangle.

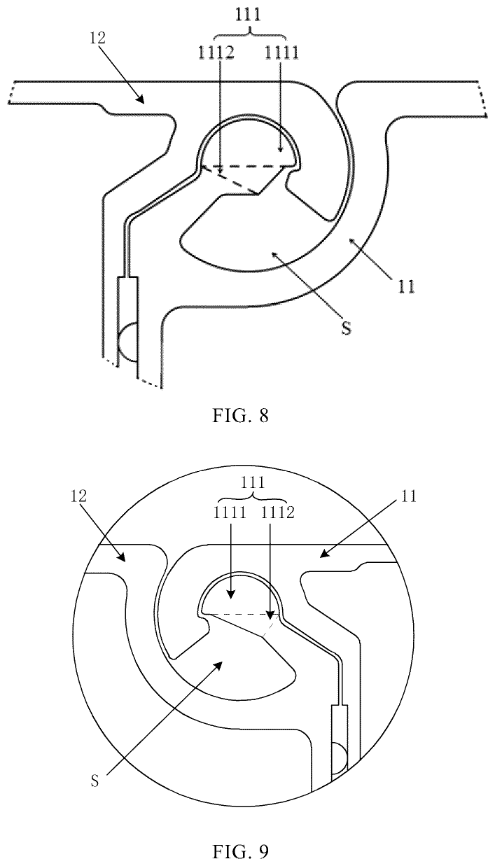

See FIG. 7, the following is a specific embodiment of the above mentioned the transition body 1112, the transition body 1112 is in the shape of a trapezoid.

See FIG. 8, the following is a specific embodiment of the above mentioned the transition body 1112, the transition body 1112 is in the shape of a V-shape.

By specifically providing the possible shapes of the transition body 1112, the space occupied by the transition body 1112 is reduced, and the range of the rotation space is expanded.

See FIGS. 4 &5, the rotating part 12 further comprises a body 121, a rotating groove 123 is formed between the body 121 and the rotating part 122, the arc body 1111 is rotationally connected to the rotating groove 123. This coordinated rotation prevents interference during the rotation process.

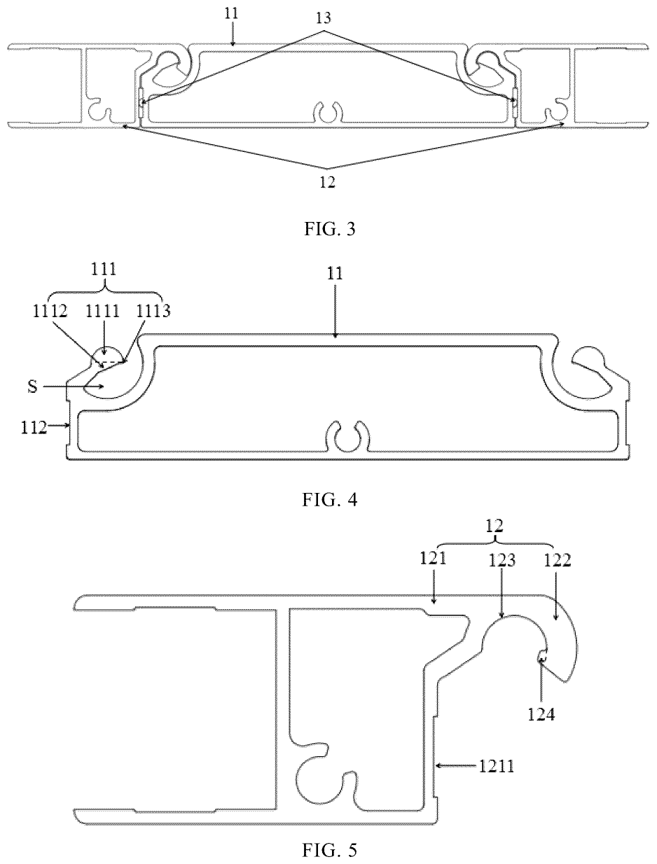

See FIG. 3, a sealing strip 13 is provided at the connection between the basic part 11 and the rotating part 12. The setting of the sealing strip 13 significantly enhances the seal between the basic part 11 and the rotating part 12, preventing rainwater and debris from entering the cargo hopper.

Further see FIGS. 4 & 5, a first groove 112 is provided along the outer side of the basic part 11, while a second groove 1211 is provided on the inner side of the rotating part 12. The first groove 112 and the second groove 1211 are provided correspondingly to form a space for accommodating the sealing strip 13. This setting specify the exact parts of the connection, wherein the first groove 112 and the second groove 1211 are arranged opposite to each other to form a space for accommodating the sealing strip 13.

See FIG. 2, an end cap assembly 4 is also provided, which includes a first end cap 141 and a second end cap 142 rotatably connected to both sides of the first end cap 141. The first end cap 4 is provided at the end of the basic part 11, while the second end cap 142 is provided at the end of the rotating part 12. The second end cap 142 is rotationally connected with the first end cap 141. The end cap assembly 4 seals the ends of the basic part 11 and the rotating part 12, while also improving the aesthetic appearance.

Wherein the first end cap 141 is connected to the basic part 11 by fasteners, and the second end cap 142 connects the rotating part 12 and the frame by fasteners.

The present invention discloses a pickup truck rear cover, see FIG. 1, assembled from multiple panel components 2 spliced together, which are rotatably connected through the rotating shaft structure 1 to allow angular variation between the panel components 2. This setting enables the angle variation between the multiple panel components 2.

Further see FIG. 1, each panel components 2 comprises a panel body and multiple frames surrounding it. This setting enhances the overall strength and stability.

Further see FIG. 1, the pickup truck rear cover is provided with a flat state and a folded state. This setting allows the pickup truck rear cover to switch between the flat state and the folded state according to different usage scenarios.

### Embodiments 2

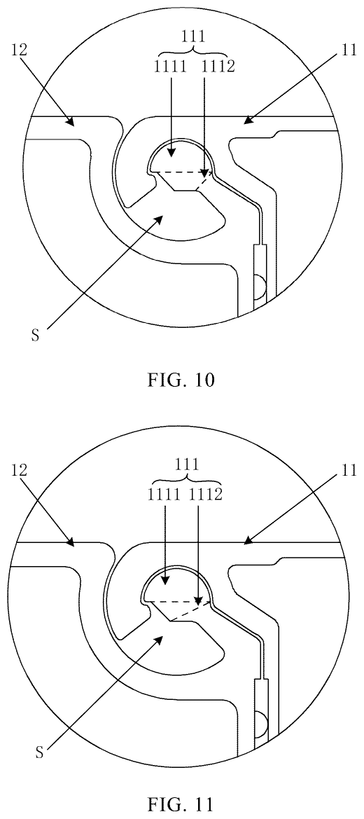

See FIGS. 9, 10 &11, the present invention discloses a rotating shaft structure 1, comprising a basic part 11, which is provided with at least one rotation space(S) along the horizontal direction, a path is formed inside the rotation space S. A limiting body 111 is arranged at the opening of the rotation space S. The limiting body 111 includes an arc body 1111 and a transition body 1112. The rotating body 11 moves along the path inside the rotation space S, enabling relative angular displacement between the rotating part 12 and the basic part 11.

It should be noted that the difference between Embodiment 2 and Embodiment 1 is as follows: In Embodiment 1, the rotation space S and the limiting body 111 are provided on the basic part 11. In Embodiment 2, the rotation space S and the limiting body 111 of the rotating shaft structure is provided on the rotating part 12. Accordingly, the structures that cooperate with the rotation space S and the limiting body 111, such as the rotating body 122, need to be adjusted to the basic part 11.

It should be noted that the connection of the structures in Embodiment 2 can refer to the description in Embodiment 1, which will not be repeated in Embodiment 2, The position of the rotating body 122 is adjusted correspondingly following a change in the position of the rotating space S and the limiting body 111, The mutual coordination remains unchanged, and the specific details can also be referred to in the detailed description of Embodiment 1.

Furthermore, FIGS. 9, 10, and 11 respectively show partial schematic diagrams of the transition body in Embodiment 2, where the shapes are sequentially: triangle, trapezoid, and V-shape. The description of the specific connection method is similar to that in Embodiment 1, and will not be repeated here.

In the description of this specification, specific features, structures, materials, or characteristics may be combined in any one or more embodiments or examples in a suitable manner.

The invention is not limited to the above-mentioned optional embodiments. Anyone can come up with various other forms of products under the inspiration of the invention, however, regardless of any changes in its shape or structure. All technical solutions that fall within the scope defined by the claims of the present invention shall fall within the scope of protection of the invention.

What is claimed is:

1. A rotating shaft structure, comprising:
a basic part provided with at least one rotation space along a horizontal direction, wherein a path is formed inside the rotation space, a limiting body is arranged at an opening of the rotation space, wherein the limiting body comprises an arc body and a transition body, wherein a contact surface is formed between the arc body and the transition body;
a rotating part provided with a rotating body, with a contact body on a side of the rotating body facing the contact surface,
wherein the rotating body moves along the path inside the rotation space, enabling relative angular displacement between the rotating part and the basic part, and
when the rotating part and the basic part are in a horizontal state, the contact body clamps the contact surface to restrict a connection state between the basic part and the rotating part.

2. The rotating shaft structure according to claim 1, wherein a portion of the transition body located within the rotation space is reduced to enlarge the rotation space.

3. The rotating shaft structure according to claim 1, wherein the transition body is in the shape of a triangle or a trapezoid or a V-shape.

4. The rotating shaft structure according to claim 1, wherein the rotating part further comprises a body, a rotating groove is formed between the body and the rotating part, the arc body is rotationally connected to the rotating groove.

5. The rotating shaft structure according to claim 1, wherein a sealing strip is provided at a connection between the basic part and the rotating part.

6. The rotating shaft structure according to claim 5, wherein
a first groove is provided along an outer side of the basic part;
a second groove is provided on a inner side of the rotating part;
the first groove and the second groove are provided correspondingly to form a space for accommodating the sealing strip.

7. The rotating shaft structure according to claim 1, wherein
a first end cap is provided at an end of the basic part;
a second end cap is provided at an end of the rotating part;
the second end cap is rotationally connected with the first end cap;
wherein the first end cap is connected to the basic part by fasteners, and the second end cap connects the rotating part and a frame by fasteners.

8. A pickup truck rear cover, comprising a rotating shaft structure as claimed in claims 1, wherein the pickup truck rear cover is assembled from multiple panel components spliced together, which are rotatably connected through the rotating shaft structure to allow angular variation between the panel components.

9. The pickup truck rear cover according to claim 8, wherein each of the multiple panel components comprises a panel body and multiple frames surrounding the panel body.

10. The pickup truck rear cover according to claim 8, wherein the pickup truck rear cover is provided with a flat state and a folded state.

11. The pickup truck rear cover according to claim 8, wherein a portion of the transition body located within the rotation space is reduced to enlarge the rotation space.

12. The pickup truck rear cover according to claim 8, wherein the transition body is in the shape of a triangle or a trapezoid or a V-shape.

13. The pickup truck rear cover according to claim 8, wherein the rotating part further comprises a body, a rotating groove is formed between the body and the rotating part, the arc body is rotationally connected to the rotating groove.

14. The pickup truck rear cover according to claim 8, wherein a sealing strip is provided at the connection between the basic part and the rotating part.

15. The pickup truck rear cover according to claim 14, wherein
a first groove is provided along an outer side of the basic part;
a second groove is provided on a inner side of the rotating part;
the first groove and the second groove are provided correspondingly to form a space for accommodating the sealing strip.

16. The pickup truck rear cover according to claim 8, wherein
a first end cap is provided at an end of the basic part;
a second end cap is provided at an end of the rotating part;
the second end cap is rotationally connected with the first end cap;
wherein the first end cap is connected to the basic part by fasteners, and the second end cap connects the rotating part and a frame by fasteners.

17. A rotating shaft structure, comprising:
a basic part, which is provided with at least one rotation space along a horizontal direction, wherein a path is formed inside the rotation space, wherein a limiting body is arranged at an opening of the rotation space, wherein the limiting body includes an arc body and a transition body, wherein
the rotating body moves along the path inside the rotation space, enabling relative angular displacement between the rotating part and the basic part.
